(19) United States
(12) Patent Application Publication
(10) Pub. No.: US 2015/0119442 A1
(43) Pub. Date: Apr. 30, 2015

(54) Biocide agents against marine woodborers

(71) Applicant: Michael Igelso Hvidt, Gentofte (DK)

(72) Inventor: Michael Igelso Hvidt, Gentofte (DK)

(73) Assignee: Teredo Marine Protection ApS, Svendborg (DK)

(21) Appl. No.: 14/120,471

(22) Filed: May 22, 2014

Related U.S. Application Data
(63) Continuation of application No. 13/063,396, filed on May 18, 2011, now abandoned.
(60) Provisional application No. 61/095,781, filed on Sep. 10, 2008.

(30) Foreign Application Priority Data
Sep. 10, 2008 (DK) PA200801266

(51) Int. Cl. A01N 25/02; A01N 37/44

(52) U.S. Cl. CPC A01N 25/02; A01N 37/44
USPC 514/425; 514/566; 514/547; 514/548

(57) ABSTRACT

The present invention relates to biodegradable biocide agents against marine woodborers. In particular, the present invention relates to novel slow releasing biocide impregnating solutions against marine woodborers, and methods of creating anti marine woodborer environments.

### TECHNICAL FIELD OF THE INVENTION

The present invention relates to biodegradable biocide agents against marine woodborers. In particular, the present invention relates to novel slow releasing biocide impregnating solutions against marine woodborers, and methods of creating anti marine woodborer environments. The invention further relates to biodegradable biocide agents against larvae of marine wood borers.

### BACKGROUND OF THE INVENTION

Marine woodborers, such as the marine bivalve molluscs, are a group of saltwater clams with reduced shells, notorious for boring into and consequently destroying wooden structures which are immersed in sea water, such as piers, docks and wooden ships. They are marine bivalve molluscs also called shipworms.

Attack by shipworms often only appears as small holes into which the larvae have disappeared. In the first year, shipworms are male, then changing to female. Reproduction occurs by male and female worms releasing semen and eggs to the water, after which fertilisation and hatching occurs freely in the water.

When the shipworm larvae are only a few days old, they seek out and start burrowing into wood that will provide them with life-long food and shelter. By gripping the wood with their feet, they can press their shells tightly against the surface, and rasp it by opening their shell valves. The shipworm lines the burrow with a calcareous coating, which protects it from being crushed by the swelling timber. A shipworm can be up to 60 cm long and 0.8 cm in diameter.

The destructive behaviour of shipworm has earned shipworms the nickname “termites of the sea”. Shipworms have been known for a long time, and it was said that Christopher Columbus himself was marooned on Jamaica in 1503 due to shipworm infestation sinking his expedition ships.

If a wooden structure such as a pier becomes infested with shipworm it may only be a matter of months before the structural integrity of the pier or part of the pier becomes compromised to an extent where it is necessary to replace some or all of the poles.

Consequently, much effort has gone into developing methods to and products that prevent and/or counter attack from shipworm.

One method is to use exotic wood types that are not attacked by shipworm. However, these exotic wood types are typically expensive, and do not help save existing wooden structures from shipworm attack.

Several methods use mechanical barriers to prevent shipworm infestation, e.g. covering wooden items such as a ships hull or poles with glass fibre, concrete or plastic products, such as shrink wrap. The mechanical barriers are typically costly and/or cumbersome to implement to wooden items already situated in a marine environment.

Other methods use chemical means to prevent or stop shipworm attack. One of the oldest methods are to use copper nails hammered into the wooden items they are to protect. Another method is creosote, CCA and CCB coating. These methods are generally regarded as environmentally hazardous, in addition to being cumbersome to implement to wooden items already situated in a marine environment.

WO 03/035342 describes a method of impregnating wooden items, in particular wooden poles situated in a marine environment to protect against shipworm attack. The impregnating agent can further consist of alcohol, soda, citric acid in addition to a biodegradable chelating agent and water.

The impregnating agent described above in WO 03/035342 leaches into the surrounding environment over time, and will have to be replenished. If the impregnating agent leaches to fast, the method of impregnating wooden items will be less economically feasible. It has been found that some of the biodegradable chelating agents leaches too fast, and consequently are less economically feasible.

Consequently, there is a need to provide further biodegradable impregnating agents for wooden items, impregnating agents that will be released more slowly, as well as methods that modify the release of impregnating agents.

### SUMMARY OF THE INVENTION

The present invention was made in view of the prior art described above, and the object of the present invention is to provide a practical method of creating a slow releasing anti marine woodborer environment as well as novel biocide-impregnating solutions against marine woodborers used in said method.

To solve the problem, the present invention provides a biocide-impregnating solution against marine woodborers comprising water, a biodegradable marine woodborer biocide component, at least one alcohol, and a source of carbonate.

In one embodiment the biodegradable marine woodborer biocide component comprises one or more aminopolycarboxylate complexing agents, such as (S,S)-ethylenediamine-disuccinate (EDDS), and in a specific embodiment it consists of water, (S,S)-EDDS (1.5-20%), ethanol (5-10%), and sodium carbonate (5-10%), and the pH of the solution may be 4.5 or lower.

In another embodiment, at least one of the carboxylate moieties of the aminopolycarboxylate complexing agents in the biocide-impregnating solution is activated for crosslinking to chemical structures present in wood, for example as an active ester.

In another embodiment the biocide-impregnating solution further comprises a cross-linking agent

In another embodiment at least one of the carboxylate moieties of the aminopolycarboxylate complexing agents (APC) is activated and has the following structure:

APC-X-Linker-Y

Wherein X is an ester or an amide; Linker is any suitable linker, or can be absent; Y is a chemical group capable of forming at least one covalent bond to chemical structures present in wood.

Another aspect of the invention is a method of creating an anti marine woodborer environment, wherein the method comprises introducing a biocide-impregnating solution into wood.

In a specific embodiment the method comprises introducing into wood an activated aminopolycarboxylate complexing agent (APC) with the following structure:

APC-X-Linker-Y

Wherein X is an ester or an amide; Linker is any suitable linker, or can be absent; Y is a chemical group capable of forming at least one covalent bond to chemical structures present in wood.

In another embodiment the method of creating an anti marine woodborer environment comprises introducing into wood a biocide-impregnating solution followed by a cross-linking agent. In another embodiment a cross-linking agent is introduced into the wood followed by a biocide-impregnating solution.

In another aspect of the invention a biocide-impregnating solution against marine woodborers consisting of water, a biodegradable marine woodborer biocide component consisting of one or more aminopolycarboxylate complexing agents, at least one alcohol, and a source of carbonate is provided.

In an embodiment of the biocide-impregnating solution, the one or more aminopolycarboxylate complexing agents has been chosen from the group consisting of: (S,S)-ethylenediamine-disuccinate (EDDS), (R,R)-ethylenediaminedisuccinate, (R,S)-ethylene-diaminedisuccinate, disodium 2-hydroxyethyliminodiacetic acid (Na₂HEIDA), sodium dihydroxyethylglycine (NaDEG), and mixtures thereof.

In another aspect of the invention, a method of prolonging service life of wood situated in a marine environment characterised by introducing a biocide-impregnating solution free from metals selected from the group consisting of transitional metals, group IIA, IIIB, IVB, VB and VIB metals and further comprising one or more aminopolycarboxylate complexing agents into the wood is provided.

In an embodiment of the method of prolonging service life of wood situated in a marine environment, the one or more aminopolycarboxylate complexing agents has been chosen from the group consisting of: (S,S)-ethylenediamine-disuccinate (EDDS), (R,R)-ethylenediaminedisuccinate, (R,S)-ethylene-diaminedisuccinate, disodium 2-hydroxyethyliminodiacetic acid (Na₂HEIDA), sodium dihydroxyethylglycine (NaDEG), and mixtures thereof.

In another embodiment of the method of prolonging service life of wood situated in a marine environment, the one or more aminopolycarboxylate Complexing agents is (S,S)-ethylenediamine-disuccinate (EDDS).

### BRIEF DESCRIPTION OF THE DRAWINGS

FIG. 1 is a picture of thirty wood specimens after impregnation and ready to be submerged in the ocean.

FIG. 2 is a comparison between shipworm infestations in untreated wood vs. wood treated with a 10% Octaquest® E30 (30% trisodium EDDS solution in water) biocide-impregnating solution after 6 months exposure at the test site in Skagen, Denmark. Several holes made by shipworm is present in the untreated specimens.

### DETAILED DESCRIPTION OF THE INVENTION

Biocide-impregnating solutions according to the invention comprise two elements 1) a biocide or mixture of biocides against marine woodborers, 2) a carrier medium. Additives can further be added to the biocide-impregnating solution to e.g. improve uptake of the biocide-impregnating solution during impregnation of wooden items, or to modify the time it takes to release the biocide-impregnating solution to the surroundings. The biocide-impregnating solutions may be supplied as concentrates that can be diluted to an appropriate concentration for impregnation.

Common to all biocide-impregnating solutions according to the invention is that they are essentially free from metals selected from the group consisting of transitional metals, group IIA, IIIB, IVB, VB and VIB metals. By essentially free from metals is to be understood that metal salts of the above kind are comprised in or being added to the biocide-impregnating solution. Exemplary transition metals comprise Fe, Zn, Cr, Mn; exemplary group IIA metals comprise Mg, Ca; exemplary group IIIB metals comprise Al, Ga; exemplary group IVB metals comprise Sn, Ge; exemplary group VB metals comprise Sb; exemplary group VIB metals comprise Po.

The methods and biocide-impregnating solutions against marine woodborers of the present invention have been illustrated with reference to shipworms. However, a person skilled in the art will appreciate that the invention can be applied to all kinds of marine woodborers, such as, but not limited to, teredine bivalves (shipworm), limnorid isopods (gribbles), pholads and specific crustacean borers, and their larvae.

In one aspect of the invention a biocide-impregnating solution against marine woodborers comprising a biodegradable marine woodborer biocide component, and at least one of the following: water, at least one alcohol, and a source of carbonate is provided. In one embodiment a biocide-impregnating solution against marine woodborers comprising a biodegradable marine woodborer biocide component, water, at least one alcohol, and a source of carbonate is provided. Water is used as the carrier component as it is capable of dissolving many of the biodegradable marine woodborer biocides. The at least one alcohol and a source of carbonate is added as an additive, and allows for better penetration of the biocide-impregnating solution in the wooden items. Alcohols can be of the formula R₁—OH, and may be chosen from the group wherein R₁ is a branched or straight-chain C1-C8 alkyl, such as methanol, ethanol, 1-propanol, 2-propanol, 1-butanol, 2-butanol, Cert-butanol, 1-pentanol, 2-pentanol, 3-pentanol, n-hexanol, n-heptanol, n-octanol. The source of carbonate may be any mixture of sodium bicarbonate (NaHCO₃), sodium carbonate (Na₂CO₃) or hydrogen carbonate (H₂CO₃). In one embodiment the biocide-impregnating solution against marine woodborers comprises a biodegradable marine woodborer biocide component, and at least one of the following: water, at least one alcohol, and a source of carbonate. In another embodiment the biocide-impregnating solution against marine woodborers is against larvae of marine woodborers.

Typical concentrations for both sodium carbonate and alcohol can be from 2.5-30%, e.g. 2.5-20%, 2.5-15%, 5-30%, 5-20%. Typical concentrations of the biodegradable marine woodborer biocide component can be from 1-50%, e.g. 5-50%, 5-40%, 5-30%, 5-20%, 10-20%, 10-30%, 10-40%, 10-50%, 20-50%, 20-40%, 20-30%, 30-50%, 30-40%.

In one embodiment the composition of the biocide-impregnating solution against marine woodborers consists of an aqueous biodegradable marine woodborer biocide component (10-20%), ethanol (5-10%), sodium carbonate (5-10%).

It is an object of the present invention to provide biodegradable marine woodborer biocides that further do not leach considerably over time, as the existing chemical means to prevent or stop attack from marine woodborers are considered environmentally hazardous. This was prompted by the increased consumer, regulatory and industry interest in clean technology (Cleantech) that has a lower environmentally impact on the natural environment. By leaching considerably is meant that an at least effective amount of the active ingredient should be present for at least 1 year, preferably for 5 years. Methods of determining the effectiveness of an active ingredient may be determined using the guidelines and recommendations in EN 275: 1992—Wood preservatives—Determination of the protective effectiveness against marine borers.

In one embodiment, the biodegradable marine woodborer biocide component comprises one or more aminopolycarboxylate complexing agents. These complexing agents are good at sequestering metals, such as calcium present in the tunnels created by shipworms and/or the shells used for burrowing present in marine woodborers. Without wanting to be bound by this theory, the inventors believe that several modes of action of the biocide component are responsible for the effectiveness of the biocide component. It may deprive the marine woodborers of calcium in several ways, for instance: the biocide component can extract calcium from the shells used for burrowing. This leads to embrittlement, and eventually results in that the marine woodborer being unable to use the shells for boring into the wood. Another mode of action can be to embrittle the calcareous tunnels that shipworm create leading to a collapse/swelling of the tunnel resulting in the shipworm being crushed. Consequently, the biocide works both preventive in hindering attack from shipworm and gribbles, and actively by removing existing shipworm and gribble infestations.

In another embodiment the aminopolycarboxylate complexing agents has been chosen from the group comprising: (S,S)-ethylenediamine-disuccinate (EDDS), (R,R)-ethylenediaminedisuccinate, (R,S)-ethylene-diaminedisuccinate, disodium 2-hydroxyethyliminodiacetic acid (Na₂HEIDA), sodium dihydroxyethylglycine (NaDEG), and mixtures thereof.

In another embodiment the aminopolycarboxylate complexing agents may be chosen from the group comprising sodium polyaspartate, sodium iminodisuccinate, sodium gluconate and sodium glucoheptonate.

In another embodiment the aminopolycarboxylate complexing agents has been chosen from the group consisting of: (S,S)-ethylenediamine-disuccinate (EDDS), (R,R)-ethylenediaminedisuccinate, (R,S)-ethylene-diaminedisuccinate, disodium 2-hydroxyethyliminodiacetic acid (Na₂HEIDA), sodium dihydroxyethylglycine (NaDEG), and mixtures thereof.

In another embodiment the aminopolycarboxylate complexing agents may be chosen from the group consisting of sodium polyaspartate, sodium iminodisuccinate, sodium gluconate and sodium glucoheptonate.

Sodium polyaspartate is also known as polymerized aspartic amino acid, and sodium iminodisuccinate is a maleic acid derivative. Both compounds chelates with multiple types of divalent and trivalent ions such as calcium ions. Sodium gluconate and sodium glucoheptonate are commonly used for chelation of mineral vitamins such as calcium, magnesium, iron, manganese, and copper.

Disodium hydroxyethyleneiminodiacetic (Na₂HEIDA) is one of the few amino carboxylic acid complexing agents that are readily biodegradable. It is useful for the chelation of divalent and trivalent ions such as calcium ions.

In another embodiment the aminopolycarboxylate complexing agent is (S,S)-ethylenediamine-disuccinate (EDDS) depicted below as the trisodium salt.

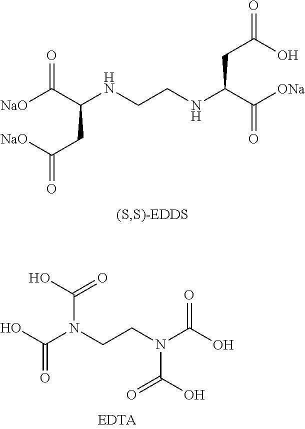

EDTA and phosphonates are non-biodegradable complexing agents that are used extensively in domestic and industrial applications. There are environmental concerns that once in river systems complexing agents can extract heavy toxic metals from mud and sediment and cause remobilization of the metals in the environment that may have adverse long term effects. EDDS is readily biodegradable and is completely mineralised in the environment. EDDS therefore cannot remobilize heavy metals as it will be biodegraded quickly upon release into the ocean. EDDS is classified as non-hazardous. Using EDDS reduces the environmental impact of chelates in formulations while maintaining the chelate performance.

EDDS is a structural isomer of EDTA that possesses two chiral centres that are the key to its biodegradability. EDDS consists of two aspartic acid units linked together by an ethylene bridge. The (S,S)-EDDS form is based on the naturally occurring amino acid L-aspartic acid, and is readily biodegradable as opposed to EDTA.

Using biodegradable complexing agents such as EDDS is a more environmentally safe alternative to the hazardous and toxic alternatives described in the background section. EDDS has further achieved the EU flower, which is a symbol of superior environmental quality.

While EDDS has proved an effective biodegradable biocide against shipworm in the course of one season, 6 months, (see example 3) its retention in the impregnated wooden item necessitates the replenishment of the impregnating agent once every season/year in order to maintain an effective anti-marine woodborer environment.

Without wanting to be bound by this theory, the inventors believe that EDDS is released into the surroundings when impregnated in a wooden item, as can be seen in example 1. Consequently, methods or additives that modify the release of EDDS, and other aminopolycarboxylate complexing agents is desirable.

In another embodiment the biocide-impregnating solution is provided, where the pH of the solution is lower than 7. Typically a pH lower than 4, e.g. pH around 1-2, 1-3, 1-4, 2-3, 2-3.5 will provide a slow release that prolongs the effect of the biocide-impregnating solution. Without wanting to be bound by this theory, the inventors believe that pH lower than 7 will precipitate the biodegradable aminopolycarboxylate complexing agents, which in time will be slowly released as the sea-water (that has a higher pH around 7.5-8.0) slowly increases the pH and thereby releases the biocide more slowly than without pH control.

In another embodiment a biocide-impregnating solution against marine woodborers consisting of water, a biodegradable marine woodborer biocide component consisting of one or more aminopolycarboxylate complexing agents, at least one alcohol, and a source of carbonate is provided.

In another embodiment of the biocide-impregnating solution, the one or more aminopolycarboxylate complexing agents has been chosen from the group consisting of: (S,S)-ethylenediamine-disuccinate (EDDS), (R,R)-ethylenediaminedisuccinate, (R,S)-ethylene-diaminedisuccinate, disodium 2-hydroxyethyliminodiacetic acid (Na₂HEIDA), sodium dihydroxyethylglycine (NaDEG), and mixtures thereof.

In another aspect of the invention, a method of prolonging service life of wood situated in a marine environment characterised by introducing a biocide-impregnating solution free from metals selected from the group consisting of transitional metals, group IIA, IIIB, IVB, VB and VIB metals and further comprising one or more aminopolycarboxylate complexing agents into the wood is provided.

Exemplary wood situated in a marine environment is e.g mooring posts, poles used as part of bridge structures, docks and piers, and support for structures such as houses and the like.

Prolonging the service life of wood situated in a marine environment is a result of the effect the aminopolycarboxylate complexing agent has on reducing the attack of marine woodborers on wood situated in a marine environment, see e.g. FIG. 2.

In an embodiment of the method of prolonging service life of wood situated in a marine environment, the one or more aminopolycarboxylate complexing agents has been chosen from the group consisting of: (S,S)-ethylenediamine-disuccinate (EDDS), (R,R)-ethylenediaminedisuccinate, (R,S)-ethylene-diaminedisuccinate, disodium 2-hydroxyethyliminodiacetic acid (Na₂HEIDA), sodium dihydroxyethylglycine (NaDEG), and mixtures thereof.

In another embodiment of the method of prolonging service life of wood situated in a marine environment, the one or more aminopolycarboxylate complexing agents is (S,S)-ethylenediamine-disuccinate (EDDS).

In another embodiment at least one of the carboxylate moieties of the aminopolycarboxylate complexing agents is activated for crosslinking to chemical structures present in wood, such as e.g. the OH groups present in cellulose, hemicellulose, pectin and starch (in the rest of the description only reference to cellulose will be made, and it will be understood by the skilled person that any compound present in wood containing a hydroxyl group or other functional group such as amine or aldehyde on an organic structure can be used in crosslinking). Consequently, the release of the aminopolycarboxylate complexing agents may be modified, by reversibly crosslinking the carboxylate moieties of the aminopolycarboxylate complexing agents to the structure of the wood.

Cellulose is one of the main constituents in wood, and is a polysaccharide consisting of a linear chain of several hundred to over ten thousand β(1→4) linked D-glucose units as exemplified below.

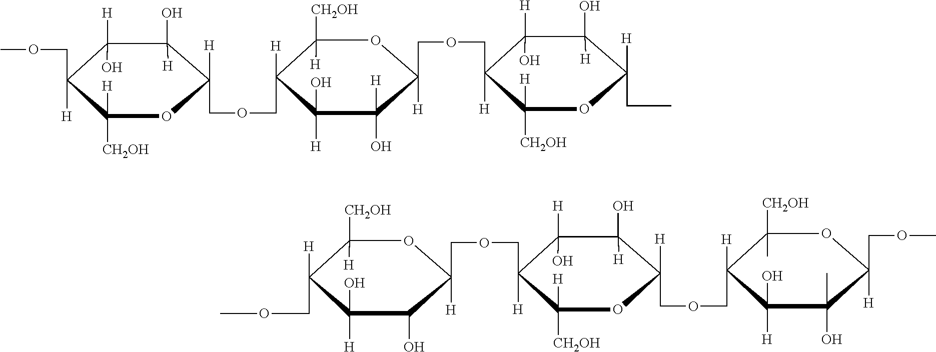

Crosslinking of carboxylic acid moieties with hydroxyl moieties are well-known to the skilled person. Typically the carboxylic acid moiety is linked directly to the hydroxyl moiety of cellulose to form an ester. Several methods for activating carboxylic acids for reaction with esters exist. In one embodiment the carboxylate moieties of the aminopolycarboxylate complexing agents is provided as an active ester such as the activated esters: succimidyl ester (NHS), tetrafluorophenyl ester (TFP) or sulfodichlorophenyl ester (SDP).

The aminopolycarboxylate complexing agents may be mono-, di-, tri-, tetra-, or poly-activated and/or mixtures thereof. A single tetra-activated aminopolycarboxylate complexing agent may form up to four esters with cellulosic hydroxyls present in wood, and consequently all four esters must be hydrolysed before the aminopolycarboxylate complexing agent can be released from the site where it is immobilized. The aminopolycarboxylate complexing agent is consequently released more slowly depending on the number of ester bonds made per aminopolycarboxylate complexing agent.

In another embodiment the biocide-impregnating solution further comprises a cross-linking agent that facilitates the cross-linking to the wooden item. Cross-linking agents are well-known to the skilled person, and can for example be dicyclohexylcarbodiimide (DCC), diisopropylcarbodiimide (DIC), 1-ethyl-3,3′-dimethylaminopropyl)carbodiimide (EDC), N-[(dimethylamino)1H-1,2,3-triazolo-[4,5-b]pyridin-1-yl-methylene]-N-methylmethanaminium hexafluorophosphate (HATU), N-[(1H-benzotriazol-1-yl) (dimethylamino)methylene]-N-methylmethanaminium hexaflurophosphate N-oxide (HBTU). It is preferred to use cross-linking agents that are environmentally safe. The addition of a cross-linking agent to the aminopolycarboxylate complexing agent, allows it to be activated in situ. Typically the biocide-impregnating solution containing the aminopolycarboxylate complexing agent is mixed with the cross-linking agent immediately before the wooden item is impregnated. However, the cross-linking agent may also be added in a separate impregnating step, either before and/or after the initial impregnating solution containing the aminopolycarboxylate complexing agent is conducted.

In another embodiment a biocide-impregnating solution containing an aminopolycarboxylate complexing agent, wherein at least one of the carboxylate moieties of the aminopolycarboxylate complexing agents (APC) is activated and has the following structure:

APC-X-Linker-Y

wherein X is an ester or an amide; Linker is any suitable linker, or can be absent. The skilled person would know which suitable linkers that can be used. Examples of suitable linkers may be straight chain or branched alkyl, alkenyl, alkynyl, such as for example C1-C20 straight chain or branched alkyl, alkenyl, alkynyl, such as for example —(CH₂)ₘ—, —(CH₂)ₘ—CH═CH—(CH₂)ₙ—, —(CH₂)ₘ—C≡C—(CH₂)ₙ— wherein m and n are integer values from 0-20, or ether or polyether such as for example polyethylene glycol (PEG), ((CH₂)₂O)ₘ, wherein m is an integer from 1-20. Y is a chemical group capable of forming at least one covalent bond to chemical structures present in wood.

Suitable methods of cross-linking and cross-linking agents are described in international application WO 00/07019. For example reacting divinylsulfone (DVS) with cellulose to create a functional handle that can be derivatised with ammonia and subsequently reacted with NHS activated EDDS as shown in the following scheme.

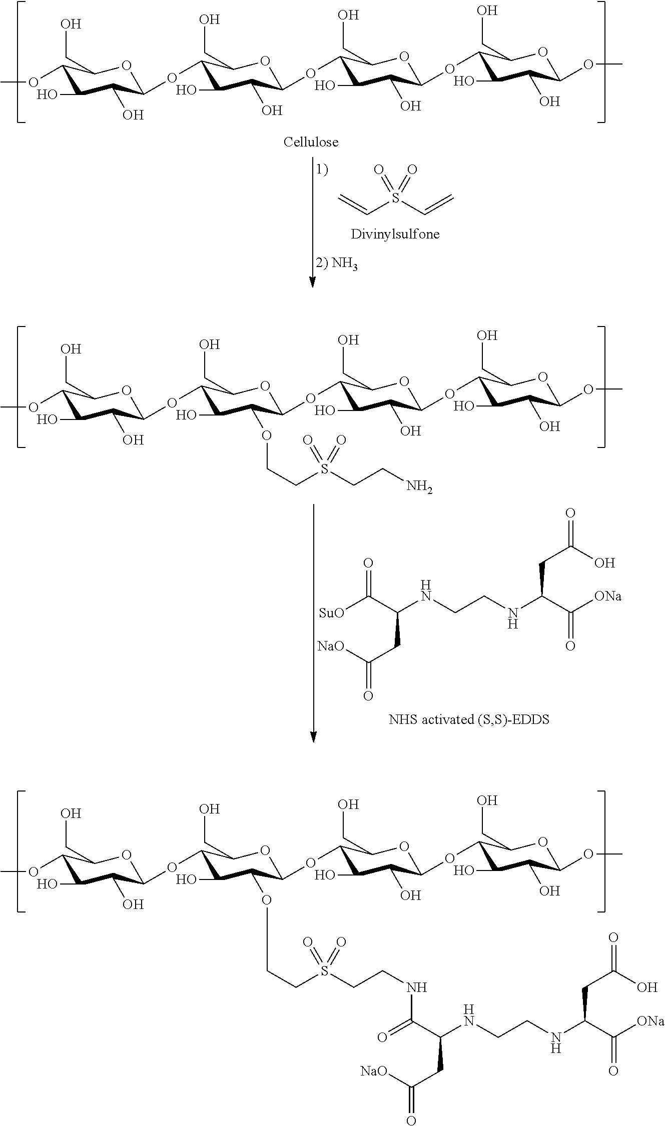

Here the aminopolycarboxylate complexing agent (APC) is exemplified as EDDS, which is amide linked (X═—HN—C(═O)—) to divinylsulfone (Linker=DVS), which is finally linked to a cellulosic hydroxyl group present in the wood.

APC-X-Linker-Y

Wherein X is an amide; Linker is divinylsulfone; Y is a vinyl group capable of forming a bond to free cellulosic hydroxyl groups. Switching from an ester to an amide crosslinker results in a more slow release, since amides are hydrolysed more slowly than the corresponding esters.

In another aspect of the invention a method of creating an anti marine woodborer environment, wherein the method comprises introducing into wood a biocide-impregnating solution. The biocide-impregnating solution may be introduced by methods well-known to the skilled person, such as for example vacuum/pressure impregnation. The biocide-impregnating solution may have any composition as described herein, e.g. the compositions described in example 1-3.

In one embodiment the method of creating an anti-marine woodborer environment, comprises introducing into wood an activated aminopolycarboxylate complexing agent (APC) with the following structure:

APC-X-Linker-Y

wherein X is an ester or an amide; Linker is any suitable linker, or can be absent; Y is a chemical group capable of forming at least one covalent bond to chemical structures present in wood is provided.

In another embodiment the method of creating an anti-marine woodborer environment, comprises introducing into wood a biocide-impregnating solution as described herein; followed by a cross-linking agent, such as for example DCC, DIC, EDC, HATU and HBTU as described above. The steps may be reversed in such a way that the cross-linking agent is added followed by the biocide-impregnating solution.

As used herein, the term “biodegradable” refers to a compound that under aerobic biodegradation in an aquatic environment, has greater than or equal to about 70% biodegradation (percentage of theoretical carbon dioxide evolution) after 28 days when measured according to the Sturm Test which has been designated Method 301B by the Organization for Economic Cooperation and Development. Preferably, the biodegradable biocides comprising the present invention have a biodegradation of greater than about 80% and, more preferably, biodegradation is greater than or equal to about 90%.

Each of the described embodiments and features applies to each aspect, as appropriate.

The following examples are merely an illustration of the invention, and should not be construed in a limiting way. Concentrations in % are w/w unless otherwise stated.

### EXAMPLES

### Example 1

### Leaching of EDDS in Sea Water

The aim of this example is to show the leaching of EDDS in sea water, as well as the effect of the pH in sea water on the leaching.

Wood specimens were produced by the Danish Technological Institute, and made of sap wood of Pinus sylvestris in the dimension: 15×25×50 mm³.

The impregnating solution used was an aqueous solution of 5% Octaquest® E30 (Innospec Limited, contains a 30% solution of trisodium-EDDS in water), 5% sodium carbonate and 5% ethanol. pH was adjusted to 4.5 with hydrochloric acid.

Three different sea water solutions were prepared using artificial sea water salt mix (Tropic Marin® Sea Salt) at half the recommended concentration (15 g/L corresponding to a specific gravity of 1010 kg/m³), normal concentration (30 g/L corresponding to a specific gravity of 1019 kg/m³) and half concentration with pH adjusted to 6. Specific gravity of sea water in the oceans range between 1020 and 1030 kg/m³. For each solution six containers were prepared each containing five specimens. Half of the specimens in each solution were end sealed at both ends using Conclad 300 2-K membrane (product no. 5305A, Condor Kemi A/S, Denmark). The end seal was applied to evaluate the radial leaching of the impregnating agent in order to simulate the surfaces exposed in harbour piers.

All specimens were weighed before and after impregnation and the uptake of liquid determined.

TABLE 1
Composition of the sea water solutions, end
sealing and distribution of specimen.

| Container no. | Specimen no. | Treatment | End sealing |
|---|---|---|---|
| 1 | 1-5 | ½ conc | + |
| 2 | 6-10 | ½ conc | + |
| 3 | 11-15 | ½ conc | + |
| 4 | 16-20 | normal conc: | + |
| 5 | 21-25 | normal conc: | + |
| 6 | 26-30 | normal conc: | + |
| 7 | 31-35 | ½ conc, pH 6 | + |
| 8 | 36-40 | ½ conc, pH 6 | + |
| 9 | 41-45 | ½ conc, pH 6 | + |
| 10 | 61-65 | ½ conc | − |
| 11 | 66-70 | ½ conc | − |
| 12 | 71-75 | ½ conc | − |
| 13 | 76-80 | normal conc: | − |
| 14 | 81-85 | normal conc: | − |
| 15 | 86-90 | normal conc: | − |
| 16 | 91-95 | ½ conc, pH 6 | − |
| 17 | 96-100 | ½ conc, pH 6 | − |
| 18 | 101-105 | ½ conc, pH 6 | − |

Impregnation Process:

Pre-vacuum: 0.1 bar for 30 minutes

Pressure: 12 bar for 120 minutes

The retention for all specimens was in the range 616 to 754 kg/m³ with an average value of 687 kg/m³. After impregnation the specimens were allowed to dry for ten days under the following conditions: 20° C. and 65% relative humidity. Then the specimens labelled 1-45 was end sealed at both end grains before the leaching study commenced, typically two weeks after the impregnation.

The specimens were placed in the containers and 500 ml of sea water solution was added to each container.

After one week the water was collected and analysed for EDDS content by HPLC-UV; detection at 254 nm. The method used involved a reverse phase column and online complexing of EDDS with Cu(II)-ions. Quantifications were made from external standards (reference material used was “−30% Na₃EDDS in water” from Fluka).

The average results of the leaching study are listed in Table 2.

TABLE 2
Leaching of EDDS, mean values and standard deviations.

| | Specimen with | Specimen without |
|---|---|---|
| Sea water Solution | end sealing (%) | end sealing (%) |
| ½ Conc. | 32.08 ± 1.01 | 34.08 ± 0.59 |
| Normal conc. | 26.48 ± 0.92 | 33.56 ± 0.62 |
| ½ conc. pH 6 | 30.07 ± 0.70 | 36.14 ± 0.89 |

In general the leaching from all sea water solutions was about 30% leaching in seven days. Leaching from end sealed specimens was significantly lower than from specimens without end sealing for all three types of sea water.

### Example 2

### Uptake of Biocide-Impregnating Solution Compared to Water

This example shows the influence of different composition of biocide-impregnating solution on the uptake of impregnation in heart wood of Pinus sylvestris using a traditional wood preservation technique.

This has been done by testing two levels of pH and two concentrations of the following ingredients: EDDS, sodium carbonate and ethanol in different combinations.

Wood specimens were made of heart wood of Pinus sylvestris in the dimension: 50×50×490 mm, which were produced by the Danish Technological Institute. The volume of each specimen was 0.001225 m³. All specimens were end sealed at one end using Conclad 300 2-K membrane (product no. 5305A, Condor Kemi AIS, Denmark).

The biocide-impregnating solution was prepared in different compositions according to Table 3. pH was adjusted with hydrochloric acid and 3-5 specimens were used for each composition (treatment no.). All specimens were weighed before and after impregnation and the uptake of liquid determined.

Preservation Process: Pre-vacuum: 0.1 bar for 30 minutes, Pressure: 12 bar for 120 minutes.

The specimens were stored in a climate chamber before use at the following conditions: 20° C. and 65% relative humidity.

TABLE 3
Composition of the tested biocide-impregnating
solutions and the average uptake

| Treatment | Octaquest | | Na₂CO₃ | EtOH | Retention | SD |
|---|---|---|---|---|---|---|
| no. | E30 (%) | pH | (%) | (%) | (kg/m³) | (kg/m³) |
| 1 | 5 | 4.5 | 5 | 5 | 316 | 141 |
| 2 | 5 | 6.5 | 5 | 5 | 258 | 117 |
| 3 | 5 | 6.5 | 10 | 5 | 373 | 137 |
| 4 | 20 | 4.5 | 5 | 5 | 372 | 204 |
| 5 | 20 | 4.5 | 5 | 10 | 475 | 147 |
| 6 | 20 | 6.5 | 10 | 5 | 250 | 89 |
| 7 | 20 | 6.5 | 10 | 10 | 301 | 101 |
| 8 | Demin. | — | — | — | 274 | 69 |
| | water | | | | | |
| 9* | Sapwood, | — | — | — | 671 | 23 |
| | demin. | | | | | |
| | water | | | | | |

*Specimens of pine sapwood without end sealing in the dimension: 15 × 25 × 50 mm

The conclusion to this experiment is that the biocide-impregnating solution is able to be retained in the wood as well as water itself, and that lowering the pH from 6.5 to 4.5 or increasing the concentration from 5% to 20% does not significantly influence the uptake of the biocide-impregnating solution in the wood.

### Example 3

### Effect of Biocide-Impregnating Agent Against Marine Woodborers

The guidelines and recommendations in EN 275: 1992—Wood preservatives—Determination of the protective effectiveness against marine borers were followed unless otherwise stated.

Wood specimens were made of sapwood of Pinus sylvestris in the dimensions: 200×75×25 mm3, with a hole ø25 mm in the centre. The specimens were produced by the Danish Technological Institute.

The biocide-impregnating solution was prepared in different compositions according to Table 4. pH was adjusted with hydrochloric acid, and 10 specimens were used for each composition of biocide-impregnating solution and each harbour exposure site.

The preservation process was as follows: Pre-vacuum: 0.10 bar for 30 minutes, Pressure: 12 bar for 120 minutes.

TABLE 4
Composition of the tested biocide-impregnating
solutions and the average retention.

| | | | | | Octaquest | |
|---|---|---|---|---|---|---|
| Octaquest | Na₂CO₃ | EtOH | Retention | SD | retention | SD |
| E30 | (%) | (%) | (kg/m³) | (kg/m³) | (kg/m³) | (kg/m³) |
| 5 | 5 | 5 | 721 | 39 | 13 | 0.7 |
| 10 | 5 | 5 | 707 | 33 | 26 | 1.2 |

The specimens were stored in a climate chamber before exposure at the following conditions: 20° C. and 65% relative humidity.

After drying for 14 days the specimens were end sealed at both ends and at the edges in the hole in the centre using Conclad 300 2-K membrane (product no. 5305A, Condor Kemi NS, Denmark).

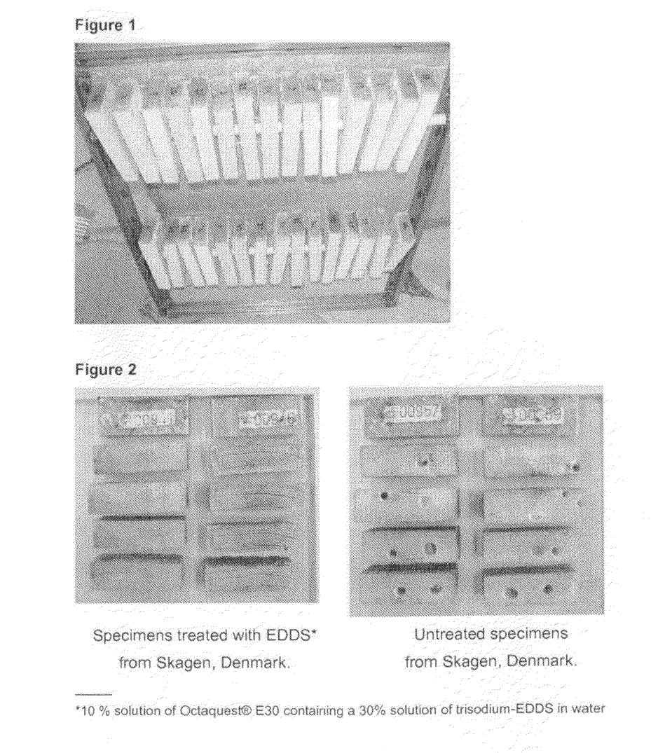

The specimens were attached to test racks and placed in two different harbours in Denmark: Skagen (northern part of Jutland) and Rudkøbing (Langeland) on 26 and 24 Apr. 2007, respectively (FIG. 1). The specimens were collected again ˜6 months later on 23 and 25 Oct. 2007, respectively.

The attack by marine borers was evaluated by cutting up the specimen in five pieces and recording the number of borers present and the percentage of the area which they had attacked.

Subsequently, chemical analysis of the content of the biocide-impregnating agent was performed by analysing for EDDS.

From each remaining specimen in a test series a small piece was removed and grinded and combined with samples from the other specimens in that series. In total five samples were analysed (only one sample of untreated wood was included).

The chemical analysis was performed as follows:

The sample (approx. 2.5 g) was extracted with milli-Q grade water for 3 hours under ultrasonification at 40° C.

The water extracts were thereafter analysed by HPLC-UV; detection at 254 nm. The method used involved a reverse phase column and online complexing of EDDS with Cu(II)-ions. Quantifications were made from external standards (reference material used was “˜30% Na₃EDDS in water” from Fluka).

The content of EDDS was calculated based on a mean density of the wood at 12% moisture content of 575 kg/m³.

The average results of the degradation of the specimens from each harbour are shown in Table 5. Unfortunately half of the specimens from Skagen harbour was lost.

TABLE 5
Average attack of marine woodborers in Rudkøbing and
Skagen and content of EDDS after 6 months exposure.

| | | | | Octaquest |
|---|---|---|---|---|
| | | Average attack | | content |
| Active | Exposure | No | Percentage of | kg/m³ |
| biocide | site | of borers | area attacked* | wood |
| Octaquest | Rudkøbing | 1.6 | 0.6 | 0.03 |
| E30 5% | | | | |
| Octaquest | Rudkøbing | 0.6 | 0.4 | 0.19 |
| E30 10% | | | | |
| Untreated | Rudkøbing | 1.4 | 0.8 | — |
| Octaquest | Skagen | 1.8 | 1.0 | 0.02 |
| E30 5% | | | | |
| Octaquest | Skagen | 0.5 | 0.3 | 0.42 |
| E30 10% | | | | |
| Untreated | Skagen | 2.4 | 1.6 | — |

*According to the rating in EN 275, Table 1.

Specimens from all three series in both harbours were attacked by marine borers. The number of attacks and the size of attacked area were significantly different from the untreated controls in both treatments containing 10% Octaquest® E30 (Innospec Limited, contains a 30% solution of trisodium-EDDS in water). The 5% treatments were not significantly different from the controls.

Despite the high degree of leaching there is a correlation between content of EDDS and the attacks of marine woodborers.

Consequently, during 6 months biocide-impregnating solutions containing 10% Octaquest® E30 (Innospec Limited, contains a 30% solution of trisodium-EDDS in water) are effective in hindering the attack of shipworm compared to control subjects (see also FIG. 2).

1. A biocide-impregnating solution against marine woodborers comprising:
(a) water,
(b) a biodegradable marine woodborer biocide component,
(c) at least one alcohol, and
(d) a source of carbonate.

2. The biocide-impregnating solution according to claim 1, wherein the biodegradable marine woodborer biocide component comprises one or more aminopolycarboxylate complexing agents.

3. The biocide-impregnating solution according to claim 2, wherein the one or more aminopolycarboxylate complexing agents has been chosen from the group comprising: (S,S)-ethylenediamine-disuccinate (EDDS), (R,R)-ethylenediaminedisuccinate, (R,S)-ethylene-diaminedisuccinate, disodium 2-hydroxyethyliminodiacetic acid (Na2HEIDA), sodium dihydroxyethylglycine (NaDEG), and mixtures thereof.

4. The biocide-impregnating solution according to claim 1, consisting of
(a) water,
(b) (S,S)-EDDS (1.5-20%),
(c) ethanol (5-10%), and
(d) sodium carbonate (5-10%).

5. A biocide-impregnating solution according to claim 1, wherein the pH of the solution is 4.5 or lower.

6. The biocide-impregnating solution according to claim 2, wherein at least one of the carboxylate moieties of the aminopolycarboxylate complexing agents is activated for crosslinking to chemical structures present in wood.

7. The biocide-impregnating solution according to claim 6, wherein at least one of the carboxylate moieties of the aminopolycarboxylate complexing agents is provided as an active ester.

8. The biocide-impregnating solution according to claim 7, wherein the active ester is succimidyl ester (NHS), tetrafluorophenyl ester (TFP) or sulfodichlorophenyl ester (SDP).

9. The biocide-impregnating solution according to claim 1, wherein the biocide-impregnating solution further comprises e) a cross-linking agent.

10. The biocide-impregnating solution according to claim 2, wherein at least one of the carboxylate moieties of the aminopolycarboxylate complexing agents (APC) is activated and has the following structure:
APC-X-Linker-Y
wherein
X is an ester or an amide;
Linker is any suitable linker, or can be absent; and
Y is a chemical group capable of forming at least one covalent bond to chemical structures present in wood.

11. A method of creating an anti marine woodborer environment, wherein the method comprises introducing into wood the biocide-impregnating solution according to claim 1.

12. The method of claim 11, wherein the biocide-impregnating solution comprises (S,S)-EDDS (1.5-20%), and at least one of the following: a) water, b) ethanol, and c) sodium carbonate.

13. The method of claim 11, wherein the biocide-impregnating solution comprises an activated aminopolycarboxylate complexing agent (APC) with the following structure:
APC-X-Linker-Y
wherein
X is an ester or an amide;
Linker is any suitable linker, or can be absent; and
Y is a chemical group capable of forming at least one covalent bond to chemical structures present in wood.

14. The method of claim 11, further comprising introducing into the wood a cross-linking agent.

15. The biocide-impregnating solution of claim 1, consisting of:
a) water,
b) a biodegradable marine woodborer biocide component consisting of one or more aminopolycarboxylate complexing agents,
c) at least one alcohol, and
d) a source of carbonate.

16. The biocide-impregnating solution according to claim 15, wherein the one or more aminopolycarboxylate complexing agents are selected the group consisting of: (S,S)-ethylenediamine-disuccinate (EDDS), (R,R)-ethylenediaminedisuccinate, (R,S)-ethylene-diaminedisuccinate, disodium 2-hydroxyethyliminodiacetic acid (Na₂HEIDA), sodium dihydroxyethylglycine (NaDEG), and mixtures thereof.

17. A method of prolonging service life of wood situated in a marine environment comprising introducing a biocide-impregnating solution free from metals selected from the group consisting of transitional metals, group IIA, IIB, IVB, VB and VIB metals and further comprising one or more aminopolycarboxylate complexing agents into the wood.

18. The method according to claim 17, wherein the one or more aminopolycarboxylate complexing agents are selected from the group consisting of: (S,S)-ethylenediamine-disuccinate (EDDS), (R,R)-ethylenediaminedisuccinate, (R,S)-ethylene-diaminedisuccinate, disodium 2-hydroxyethyliminodiacetic acid (Na₂HEIDA), sodium dihydroxyethylglycine (NaDEG), and mixtures thereof.

19. The method according to claim 17, wherein the one or more aminopolycarboxylate complexing agents is (S,S)-ethylenediamine-disuccinate (EDDS).
